(19) United States
(12) Patent Application Publication
(10) Pub. No.: US 2026/0113728 A1
(43) Pub. Date: Apr. 23, 2026

(54) COMMUNICATION CONTROL DEVICE

(71) Applicant: TOYOTA JIDOSHA KABUSHIKI KAISHA, Toyota-shi (JP)

(72) Inventor: Naoya KANEKO, Tokyo (JP)

(73) Assignee: TOYOTA JIDOSHA KABUSHIKI KAISHA, Toyota-shi (JP)

(21) Appl. No.: 19/325,836

(22) Filed: Sep. 11, 2025

(30) Foreign Application Priority Data
Oct. 17, 2024 (JP) 2024-182063

(51) Int. Cl. H04W 64/00; H04B 7/185

(52) U.S. Cl. CPC H04W 64/00; H04B 7/18513

(57) ABSTRACT

The communication control device is a communication control device of a moving body including a communication device that is capable of using a terrestrial communication network and a non-terrestrial communication network. The communication control device includes an image acquisition unit, a detection unit, an orbit information acquisition unit, and a determination unit. The image acquisition unit is configured to acquire an image produced by imaging a surrounding area of a moving body. The detection unit is configured to detect a sky area corresponding to a sky in the image. The orbit information acquisition unit is configured to acquire orbit information on a satellite configuring a non-terrestrial communication network. The determination unit is configured to determine whether to perform communication via a terrestrial communication network or to perform communication via the non-terrestrial communication network based on the sky area and the orbit information.

### CROSS-REFERENCE TO RELATED APPLICATION

This application claims priority to Japanese Patent Application No. 2024-182063 filed on Oct. 17, 2024. The disclosure of the above-identified application, including the specification, drawings, and claims, is incorporated by reference herein in its entirety.

### BACKGROUND

### 1. Technical Field

The present disclosure relates to a technical field of a communication control device.

### 2. Description of Related Art

As such a device, for example, a device that determines whether a satellite related to a satellite signal received by a satellite antenna is in a line-of-sight (LOS) state in which the satellite is directly visible from the satellite antenna or in a non-line-of-sight (NLOS) state in which the satellite is not directly visible from the satellite antenna and performs a correction process on a satellite signal related to the satellite in the NLOS state has been proposed (refer to Japanese U.S. Pat. No. 6,546,658 (JP 6546658 B)).

### SUMMARY

For example, in a case where a moving body performs at least one of satellite communication and non-terrestrial network (NTN) communication, it is needed to predict a communication state between the moving body and a satellite or the like. A trained model produced by machine learning may be used for predicting the communication state. In a technique described in JP 6546658 B, a satellite signal related to a global navigation satellite system (GNSS) is corrected, but the prediction of the communication state is not performed.

The present disclosure provides a communication control device capable of accurately predicting a communication state between a moving body and a satellite or the like.

A communication control device related to one aspect of the present disclosure is a communication control device of a moving body including a communication device configured to use a terrestrial communication network and a non-terrestrial communication network.

The communication control device includes:
an image acquisition unit configured to acquire an image generated by imaging a periphery of the moving body;
a detection unit configured to detect a sky area corresponding to a sky in the image;
an orbit information acquisition unit configured to acquire orbit information on a satellite that constitutes the non-terrestrial communication network; and
a determination unit configured to determine whether to perform communication via the terrestrial communication network or perform communication via the non-terrestrial communication network, based on the sky area and the orbit information.

A communication control device related to another aspect of the present disclosure is a communication control device of a moving body including a communication device configured to use a terrestrial communication network and a non-terrestrial communication network.

The communication control device includes:
an image acquisition unit configured to acquire an image generated by imaging a periphery of the moving body;
an orbit information acquisition unit configured to acquire orbit information on a satellite that constitutes the non-terrestrial communication network;
a prediction unit configured to predict a future position of the satellite based on the orbit information; and
a determination unit configured to determine whether to perform communication via the terrestrial communication network or perform communication via the non-terrestrial communication network, based on the image and the future position of the satellite.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration of a communication control device according to an embodiment;

FIG. 2 is a diagram for describing a state of a satellite; and

FIG. 3 is a flowchart showing an operation of the communication control device according to the embodiment.

### DETAILED DESCRIPTION OF EMBODIMENTS

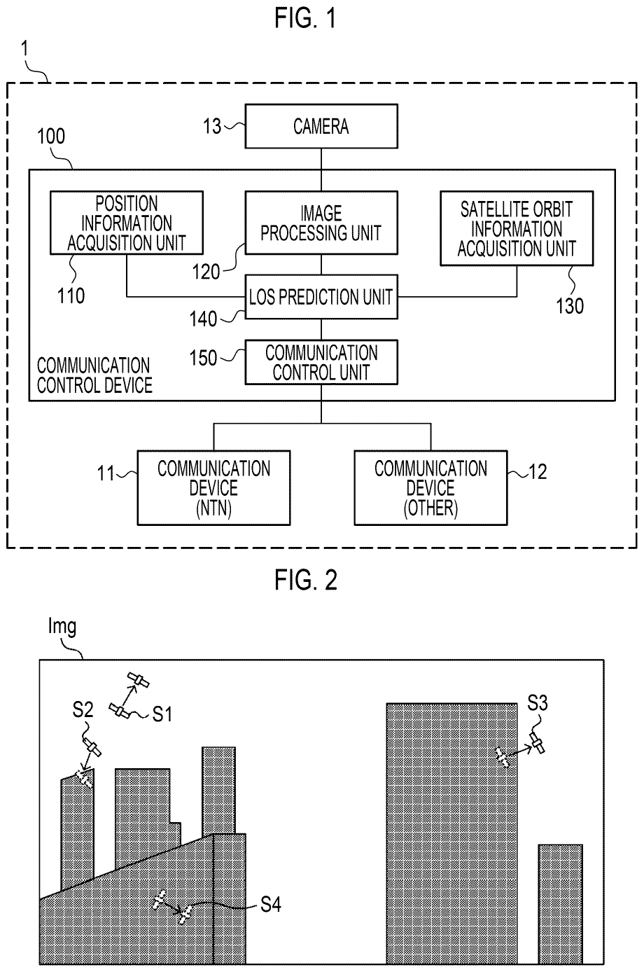

An embodiment of a communication control device will be described with reference to FIGS. 1 to 3. In FIG. 1, the communication control device 100 is mounted on the vehicle 1. The vehicle 1 includes a communication device 11, a communication device 12, and a camera 13. The communication device 11 is a communication device that uses a non-terrestrial communication network. The communication device 12 may be a communication device that uses a terrestrial communication network. That is, the communication device 12 is a communication device that uses a communication network different from the communication device 11. The vehicle 1 may be a connected car. The terrestrial communication network may include at least one of a cellular mobile line and a Wi-Fi (registered trademark) line. The camera 13 can image the surroundings of the vehicle 1. The camera 13 is particularly installed on the vehicle 1 such that the zenith can be imaged. For example, the camera 13 may be a hemispherical 360-degree camera.

The communication control device 100 includes a position information acquisition unit 110, an image processing unit 120, a satellite orbit information acquisition unit 130, a LOS prediction unit 140, and a communication control unit 150. The communication control device 100 may include the camera 13 as a part thereof. The position information acquisition unit 110 acquires position information indicating the position of the vehicle 1 and motion information of the vehicle 1 for each time. For example, the one piece of information may include latitude, longitude, altitude, speed, and direction. The time may be a satellite time, such as a global positioning system (GPS) time, or a time of an area in which the vehicle 1 travels.

The image processing unit 120 acquires a camera image produced by the camera 13 imaging the surroundings of the vehicle 1. For example, in a case where the camera 13 is a hemispherical 360-degree camera, the image processing unit 120 may perform predetermined distortion correction processing on the camera image. In this case, the image processing unit 120 may convert the camera image that is a circular image into the celestial coordinate system. Alternatively, the image processing unit 120 may perform a predetermined normalization process on the camera image that is a circular image. Thereafter, the image processing unit 120 may convert the camera image to which the normalization process is applied into the horizontal coordinate system.

The image processing unit 120 detects a sky area corresponding to the sky in the camera image. Various existing aspects may be applied to the processing for detecting the sky area. For example, the sky area may be detected based on the color information related to the camera image. For example, when the camera image is input, the sky area may be detected by using a trained model that extracts the sky area included in the camera image. The image processing unit 120 may determine that the vehicle 1 travels in the tunnel based on the position of the vehicle 1. In this case, the image processing unit 120 may determine that there is no sky area, assuming that the zenith is the top surface of the tunnel. The image processing unit 120 produces the space information indicating the sky area.

The satellite orbit information acquisition unit 130 acquires the orbit information of the base station (for example, at least one of the satellite and the aircraft) to which the communication device 11 is to be connected. The satellite orbit information acquisition unit 130 may acquire the orbit information from a server on the network or may acquire the orbit information from a storage device (not shown) included in the communication control device 100. The satellite orbit information acquisition unit 130 calculates the current position of the base station and the future orbit and direction of the base station based on the orbit information. The satellite orbit information acquisition unit 130 produces the satellite information indicating the current position of the base station and the future orbit and direction of the base station.

The LOS prediction unit 140 acquires the position information acquired by the position information acquisition unit 110, the space information produced by the image processing unit 120, and the satellite information produced by the satellite orbit information acquisition unit 130. The LOS prediction unit 140 predicts the current availability of the non-terrestrial communication network and the future availability of the non-terrestrial communication network based on the positional information, the space information, and the satellite information.

The position information acquisition unit 110 may repeatedly acquire the position information at a predetermined cycle. The image processing unit 120 may repeatedly produce the space information at a predetermined cycle. The satellite orbit information acquisition unit 130 may repeatedly produce the satellite information at a predetermined cycle. The LOS prediction unit 140 may acquire the position information, the space information, and the satellite information periodically. Therefore, the LOS prediction unit 140 may repeatedly predict the current availability of the non-terrestrial communication network and the future availability of the non-terrestrial communication network.

Here, the state of the base station configuring the non-terrestrial communication network will be described with reference to FIG. 2. The image Img shown in FIG. 2 corresponds to an example of the camera image. In the image Img, the hatched region corresponds to a structure present around the vehicle 1. In the image Img, a portion other than the hatched region corresponds to a sky area. It is assumed that the satellites S1, S2, S3, S4 as the base stations are present in the range included in the image Img. When the satellite is positioned in the sky area of the image Img, the satellite is in direct line of sight from the antenna of the communication device 11. On the other hand, in a case where the satellite is positioned in the hatched region of the image Img, the satellite cannot be directly seen from the antenna of the communication device 11. Therefore, the satellite located in the sky area of the image Img may be referred to as the LOS satellite. The satellite located in the hatched region of the image Img may be referred to as an NLOS satellite. The LOS satellite may be referred to as a “LOS satellite”. The NLOS satellite may be referred to as a “satellite without LOS”.

A position of each of the satellites S1, S2, S3, S4 (furthermore, the position of the vehicle 1) changes with time. Therefore, even though the satellite is currently the LOS satellite, there is a possibility that the satellite will be an NLOS satellite in the future. In addition, even though the satellite is currently an NLOS satellite, there is a possibility that the satellite will be an LOS satellite in the future. The arrows shown in FIG. 2 show an example of the orbit of each of the satellites. That is, the position of each of the satellites changes along the arrow. A start point side of the arrow is the current position of the satellite, and an end point side of the arrow is the future position of the satellite.

The satellite S1 is currently positioned in the sky area of the image Img. The satellite S1 is positioned in the sky area of the image Img in the future. That is, the satellite S1 is a LOS satellite at present and in the future. The state of the satellite is referred to as “active” in the present embodiment. The satellite S2 is currently positioned in the sky area of the image Img. The satellite S2 is located in a hatched region of the image Img in the future. That is, the satellite S2 is currently an LOS satellite, but becomes an NLOS satellite in the future. Such a state of the satellite is referred to as “fading” in the present embodiment. The satellite S3 is currently positioned in the hatched region of the image Img. The satellite S3 is positioned in the sky area of the image Img in the future. That is, the satellite S3 is currently an NLOS satellite, but becomes an LOS satellite in the future. The state of the satellite is referred to as “appearing” in the present embodiment. The satellite S4 is currently positioned in the hatched region of the image Img. The satellite S4 is located in a hatched area of the image Img in the future. That is, the satellite S4 is an NLOS satellite at present and in the future. The state of the satellite is referred to as “hidden”in the present embodiment.

The LOS prediction unit 140 may specify the position (that is, the coordinate) of each of the satellites S1, S2, S3, and S4 in the coordinate system related to the camera image based on the position information and the satellite information. The LOS prediction unit 140 may determine whether each of the satellites is positioned in the sky area of the image Img based on the positions of the specified satellites S1, S2, S3, S4 and the sky information.

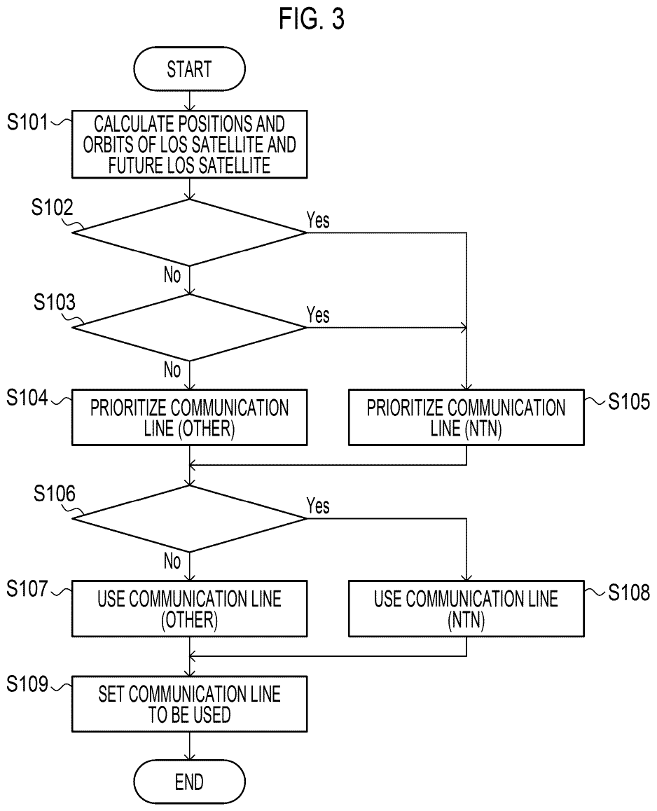

The operation of the LOS prediction unit 140 will be described with reference to the flowchart of FIG. 3. In FIG. 3, the LOS prediction unit 140 calculates the position and the orbit of the satellite that is currently the LOS satellite and the satellite that will be the LOS satellite in the future based on the position information, the space information, and the satellite information (S101). Next, the LOS prediction unit 140 determines whether there are one or more satellites that are active (S102).

In the process of S102, when determination is made that there is one or more satellites that are active (S102: Yes), the LOS prediction unit 140 decides to prefer the non-terrestrial communication network (S105). On the other hand, in the process of S102, when determination is made that there are one or more satellites that are active (S102: No), the LOS prediction unit 140 determines whether all the satellites are fading or appearing (S103).

In the processing of S103, in a case where determination is made that all the satellites are fading or appearing (S103: Yes), the LOS prediction unit 140 decides to prefer the non-terrestrial communication network (S105). On the other hand, in the process of S103, when determination is made that all the satellites are not fading and not appearing (in other words, all the satellites are hidden) (S103: No), the LOS prediction unit 140 decides to give priority to the terrestrial communication network (S104).

Thereafter, the LOS prediction unit 140 determines whether the quality of the preferred communication network is equal to or higher than the terrestrial communication network (S106). In the process of S106, when the LOS prediction unit 140 determines that the quality of the communication network to be preferentially used is equal to or higher than the terrestrial communication network (S106: Yes), the LOS prediction unit 140 decides to use the communication network to be preferentially used (S108). On the other hand, in the process of S106, when the quality of the communication network to be prioritized is determined not to be equal to or higher than the terrestrial communication network (S106: No), the LOS prediction unit 140 decides to use the terrestrial communication network (S107).

Thereafter, the LOS prediction unit 140 transmits information indicating the communication network to be used to the communication control unit 150 (S109). The information indicating the communication network to be used may be referred to as a communication line usage policy. The communication control unit 150 selects the communication device 11 or 12 based on information indicating the communication network to be used. When the non-terrestrial communication network is selected as the communication network to be used, the communication control unit 150 may set the direction and the radiation pattern of the antenna of the communication device 11.

### Technical Effect

The communication control device 100 compares the sky area in the camera image with the current and future positions of the base station based on the orbit information of the base station (for example, at least one of the satellite and the aircraft) configuring the non-terrestrial communication network. Therefore, the communication control device 100 can accurately estimate the current and future communication states between the vehicle 1 and the base station. That is, with the communication control device 100, the communication state between the vehicle 1 and the satellite or the like can be accurately predicted.

The non-terrestrial communication network can perform communication at a high speed and with a low delay as compared with the terrestrial communication network. Therefore, the non-terrestrial communication network can transmit a large amount of data at high speed as compared with the terrestrial communication network. With the communication control device 100, the non-terrestrial communication network capable of high-speed and large-capacity communication is appropriately used, so that efficient data transmission can be realized as compared with a case where solely the non-terrestrial communication network is used. Therefore, even in an environment in which connection and disconnection are likely to be repeated, the efficiency of using the non-terrestrial communication network can be improved without reducing the user experience.

Aspects of the disclosure derived from the embodiments and the modification examples will be described below.

A first aspect of the disclosure relates to a communication control device that is a communication control device of a moving body including a communication device that is configured to use a terrestrial communication network and a non-terrestrial communication network. The communication control device includes an image acquisition unit configured to acquire an image produced by imaging a periphery of the moving body, a detection unit configured to detect a sky area corresponding to a vacant space in the image, an orbit information acquisition unit configured to acquire orbit information on a satellite configuring the non-terrestrial communication network, and a determination unit configured to determine whether to perform communication via the terrestrial communication network or to perform communication via the non-terrestrial communication network based on the sky area and the orbit information.

In the embodiment, the “image processing unit 120” functions as an example of the “image acquisition unit” and the “detection unit”. The satellite orbit information acquisition unit 130 functions as an example of the “orbit information acquisition unit”. The “LOS prediction unit 140” functions as an example of the “determination unit”.

In the communication control device according to the first aspect, the communication control device may further include a prediction unit for predicting a future position of the satellite based on the orbit information. The determination unit may be configured to determine whether to perform the communication via the terrestrial communication network or to perform the communication via the non-terrestrial communication network based on the sky area and a future position of the satellite. In the embodiment, the “satellite orbit information acquisition unit 130” functions as an example of the “prediction unit”.

A second aspect of the disclosure relates to a communication control device that is a communication control device of a moving body including a communication device that is configured to use a terrestrial communication network and a non-terrestrial communication network. The communication control device includes an image acquisition unit, an orbit information acquisition unit, a prediction unit, and a determination unit. The image acquisition unit is configured to acquire an image produced by imaging a periphery of the moving body. The orbit information acquisition unit is configured to acquire orbit information on a satellite configuring the non-terrestrial communication network. The prediction unit is configured to predict a future position of the satellite based on the orbit information. The determination unit is configured to determine whether to perform communication via the terrestrial communication network or to perform communication via the non-terrestrial communication network based on the image and the future position of the satellite.

In the communication control device according to the second aspect, the communication control device may include a detection unit for detecting a sky area corresponding to a void in the image. The determination unit may be configured to determine whether to perform the communication via the terrestrial communication network or to perform the communication via the non-terrestrial communication network based on the sky area and a future position of the satellite.

The present disclosure is not limited to the embodiments. The communication control device according to the present disclosure is also appropriately modifiable within a range not departing from the gist or the idea of the disclosure that can be read from the claims and the entire specification, and the communication control device with such a modification is also included in the technical scope of the present disclosure.

What is claimed is:

1. A communication control device of a moving body including a communication device configured to use a terrestrial communication network and a non-terrestrial communication network, the communication control device comprising:
an image acquisition unit configured to acquire an image generated by imaging a periphery of the moving body;
a detection unit configured to detect a sky area corresponding to a sky in the image;
an orbit information acquisition unit configured to acquire orbit information on a satellite that constitutes the non-terrestrial communication network; and
a determination unit configured to determine whether to perform communication via the terrestrial communication network or perform communication via the non-terrestrial communication network, based on the sky area and the orbit information.

2. The communication control device according to claim 1, further comprising a prediction unit configured to predict a future position of the satellite based on the orbit information,
wherein the determination unit is configured to determine whether to perform the communication via the terrestrial communication network or perform the communication via the non-terrestrial communication network, based on the sky area and the future position of the satellite.

3. A communication control device of a moving body including a communication device configured to use a terrestrial communication network and a non-terrestrial communication network, the communication control device comprising:
an image acquisition unit configured to acquire an image generated by imaging a periphery of the moving body;
an orbit information acquisition unit configured to acquire orbit information on a satellite that constitutes the non-terrestrial communication network;
a prediction unit configured to predict a future position of the satellite based on the orbit information; and
a determination unit configured to determine whether to perform communication via the terrestrial communication network or perform communication via the non-terrestrial communication network, based on the image and the future position of the satellite.

4. The communication control device according to claim 3, further comprising a detection unit configured to detect a sky area corresponding to a sky in the image,
wherein the determination unit is configured to determine whether to perform the communication via the terrestrial communication network or perform the communication via the non-terrestrial communication network, based on the sky area and the future position of the satellite.
